(19) United States
(12) Patent Application Publication
(10) Pub. No.: US 2016/0171593 A1
(43) Pub. Date: Jun. 16, 2016

(54) Method of Purchasing Goods via Transnational Shipping and the Computer Program Product Thereof

(71) Applicant: IXORP CO., LTD., Taipei City (TW)

(72) Inventors: Mu-Jung Chang, Taipei City (TW); Huang-Yu Lin, Taipei City (TW)

(21) Appl. No.: 14/963,726

(22) Filed: Dec. 9, 2015

(30) Foreign Application Priority Data
Dec. 12, 2014 (TW) 103143402

(51) Int. Cl. G06Q 30/06; G06Q 10/08

(52) U.S. Cl. CPC G06Q 30/0637; G06Q 30/0639; G06Q 10/0833

(57) ABSTRACT

The present invention relates to a method of purchasing goods via transnational shipping and its computer program product which assists users to evaluate the required vehicles (means of transportation), required time, and expenses during the shipping process of goods, and after confirmation of the route and the purchase, directly makes reservation for each vehicle. In this way, the user can see the required time and expenses for the shipping, and choose the most suitable route according to his/her own needs. Moreover, reservation is made automatically for each vehicle service provider. As a result, the complicated procedures for placing orders on translational goods are simplified for the user.

### BACKGROUND OF THE INVENTION

1. Field of the Invention

The present invention relates to a service of shipping transnational goods, and particularly relates to a purchasing method by making route planning according to the origin and the destination points of shipment and the computer program product thereof.

2. Description of the Related Art

According to differences of geographical location, environmental conditions and cultural situations in different countries, production of various products, for instance wine, would lead to special flavors due to differences in climatic changes, soil conditions, and water quality characteristics of different production locations. Also, because of the differences in equipments and techniques, products of different qualities may be produced. Therefore, nowadays, transnational shipping of goods is not only frequent, but also various kinds of shipping vehicles and even many kinds of combinations thereof are used for transnational shipping of goods.

Transnational shipping means include land transportation, sea transportation, air transportation, and a combination of these shipping means. Sea transportation is considered be a frequently used shipping means, in which goods are loaded on a vessel and several ports are visited, where these goods are discharged and new goods are loaded onto the vessel from visited ports. Air transportation is made by loading goods on an airplane, which carries these goods to an airport. Land transportation includes use of trains or land vehicles similar to trains to carry goods on dry land.

Usually, after the goods are carried to a port or an airport via sea or air transportation, they are delivered to their final destinations via land transportation. However, nowadays, information on required shipping time and costs are scattered. While the required time for air transportation is easier to estimate, the relevant costs are relatively high. On the contrary, costs of sea transportation are relatively low; however, delays can easily occur, and the information on free/remaining container space is not easy to find. Besides, additional communications and confirmation are required for the trucks to get the goods at the destination port, which makes the whole operation complicated and inconvenient.

In summary, the prior art ways of transnational shipping of goods still have lots of inconveniences that require improvement.

### SUMMARY OF THE INVENTION

In the light of the above said problems, the present invention relates to a computer program product for purchasing goods via transnational shipping, which assists users to evaluate the required vehicles (means of transportation), required time, and expenses during the shipping process of goods, and after confirmation of the route and the purchase, directly makes reservation for each vehicle.

In order to achieve the above said purposes, the prevent invention provides a computer program product for purchasing goods via transnational shipping, comprising an origin and destination points input module, a route planning module, a data acquisition module, a display module, and a purchase confirmation module. The origin and destination points input module allows the user to input the point of departure and the destination of the goods to be shipped. The route planning module provides a list comprising at least one possible route of completing the shipping according to the points of departure and destination entered. The data acquisition module acquires data about the number of flights/runs of the vehicles used on said route, and the time and costs required for each corresponding flight/run. The display module is used to display the acquired data about the number of flights/runs, and the time and costs required for each corresponding flight/run; and also display the total required time and total costs for said route. The purchase confirmation module is used to enable the user decide on using the route or not and make the required payment.

With the present invention, users can better understand the time and money required to be spent during the process of shipping goods choose the most suitable route according to their own demands (i.e. the desired time and costs); and after making payment according to the choice made, subscription can be made automatically to each vehicle supplier, which solve the inconveniences in placing an order on translational goods.

Moreover, the data acquisition module acquires data about the number of flights/runs, and the time and costs required for each corresponding flight/run from a server through a network. In this way, the task of the data acquisition module is simplified, and the efficiency of the data acquisition module is increased.

Moreover, the invention also comprises a goods tracking module, used for showing the location of the goods. In this way, the location of goods can be advantageously known in real-time, which is good for user to understand the situation immediately, and arrange all kinds of remaining tasks according to this.

Moreover, said location of the goods is acquired from a server and downloaded to said goods tracking module, and before said goods arrive at a trans-shipment place for change of vehicle, a remainder notification is issued by said server to the contact window of the next vehicle. By means of this reminder notification, the waiting time for the transfer of goods at the port or airport is reduced, and thus shipping efficiency is improved.

Moreover, said data acquisition module can acquire real-time weather information and weather forecast information, and show the information on the display module. Moreover, the data acquisition module can also acquire information about the impact of said real-time weather information and said weather forecast information on the completion time of the route, and then show the total time and total costs required after taking into account said impacts on the route. After the real-time weather information and the weather forecast information are taken into account, the accuracy of time estimation can be improved.

Moreover, the invention also comprises a cargo weight and volume input module, which is used to enable the user to enter the weight information and the volume information of the goods; and the total required time and total required costs are re-assessed by taking into account the impacts of the weight and volume information. Thereby, variables can be reduced more, and the accuracy of the whole timetable and the budget estimation can be improved.

Also, the invention also comprises a shipping means selection module, which is used for allowing the user to choose the means of transportation and thus simplifies the task of selecting the remaining routes.

The present invention also relates to providing a method of purchasing goods via transnational shipping, which provides at least one shipping route according to the origin and destination points entered by the user, via the server; and also gives an estimation of the required time and costs according to the vehicles used on said shipping route; and after the user confirms the route and makes the payment, places the shipping service order to corresponding vehicle service providers.

By means of this method, the step of reserving a transportation vehicle is substantially simplified, and the most suitable route according to needs can be easily chosen, and thus the problems of the prior art would be solved.

When said server acquires data about the number of flights/runs of the vehicles used on said shipping route, and the time and costs required for each corresponding flight/run, and the real-time weather information and the weather forecast information, it also makes an estimation of the required time and costs according to the data/information acquired.

Moreover, said server also monitors the location of the goods, and before the goods arrive at a trans-shipment place for change of vehicle, it issues a reminder notification to the contact window of the next vehicle. In this way, the shipment process is made smoother and the waiting time at the port or the airport is reduced.

Flowcharts of the present invention are attached to this document, and also detailed description of the embodiments are given below, in order to it the esteemed examiner understand better the technical characteristics, contents, and the advantages of the present invention, and the relevant effects that can be achieved with the present invention. Moreover, the figures are only provided for illustration purposes and to assist the use of the description, and are not necessarily in true scale or accurate configuration according to the embodiments of the present invention; and therefore the scope of the present invention shall not be limited or interpreted Only according to the scale and configuration given in the attached figures.

### BRIEF DESCRIPTION OF THE DRAWINGS

FIG. 1 is a computer program product module flow diagram of an embodiment of the present invention.

FIG. 2 is a module flow diagram of an embodiment of the present invention, where the transnational goods shipping and purchasing computer program product is also combined with a goods monitoring module.

FIG. 3 is a module flow diagram of an embodiment of the present invention, where the computer program product is also combined with a module of selecting the way of shipment.

### DETAILED DESCRIPTION OF THE PREFERRED EMBODIMENTS

In order to provide better understanding of the invention, and describe method of the present invention in more detail, it should be noted that, the “route” or “shipping route” used in the present embodiment refers to the way between the point of departure and point of destination, and it does not restrict the type or frequency of the vehicles that can be used or the route.

An embodiment of the method of purchasing goads is transnational shipping comprises providing a list comprising at least one shipping route according to the points of departure and destination entered by the user, via the server, and also comprises making an assessment about the time and money required to be spent by the vehicles used on said shipping route by taking into account the customs procedures; and after the user decides on which shipping route he/she wishes to use and makes the payment, the embodiment comprises placing order(s) to corresponding vehicle service provider(s) for shipping services.

By means of the above said method, the complex and inconvenient task of communicating with the service providers one by one is simplified for the user. Besides, the conditions of shipping can also be laid out, and re-confirmation is not necessary for those conditions that are already set, which substantially simplifies the many and complicated steps of the task and overcomes the drawbacks of the prior art.

Also, according to the vehicles to be used on said shipping route, the server can acquire data about the number of flights/runs, the time and costs required for each flight/run, and the real-time weather conditions and the weather forecast information; and according to these data/information, it can re-estimate the total time and costs required on the route, by taking into account the impacts to be caused on the shipping route by these data, which improves the accuracy for the arrival time of the order, and allows the user to plan ahead and arrange subsequent works.

Said server can also monitor the real-time location of the goods, which helps the user know where the goods are found at any time. With this method, besides letting the user know the real-time location of the goods, it is also possible to issue a reminder notification to the contact window of the next vehicle, before the goods arrive at the trans-shipment place for change of vehicle, for instance a few hours or a few days before arrival (depending on the different time schedules of different kinds of transport vehicles). In this way, the service provider is notified about the arrival, so that the efficiency of shipping is improved. Furthermore, the present embodiment can also integrate the serial numbers of the goods found in each different shipping stage, so that relate the shipping stages of the goods to each other. As a result, by means of using the serial number of the goods found in each different shipping stage, it would be possible to inquire the real-time location or situation of the goods, which helps forming interconnection between goods shipment information, and which is not limited in inquiring the serial number provided for the corresponding specific shipping stage, so that overcomes the drawbacks of the prior art technique. Moreover, the present embodiment is compatible with image capturing technique; and therefore, images of the goods can be captured, especially before and after the goods are kept waiting for transfer at the trans-shipment places. By means of comparing the images of the goods, it would be possible to confirm whether the goods are stolen or opened or not, and in this way, responsible parties for possible damages can be investigated.

Also, both the user and the vehicle service provider don't have to worry about additional financial loss. According to the known methods of transnational transactions, before mutual trust is formed between both parties, the transactions can only be made between the parties by means of a letter of credit issued by a bank, which may require a service charge by the bank as an extra expense for both parties. However, in the method of the present invention, neither the user nor the service provider needs to be concerned about this problem, since there would be no direct money transfer between the parties, which would cut down on the bank expenses of both parties.

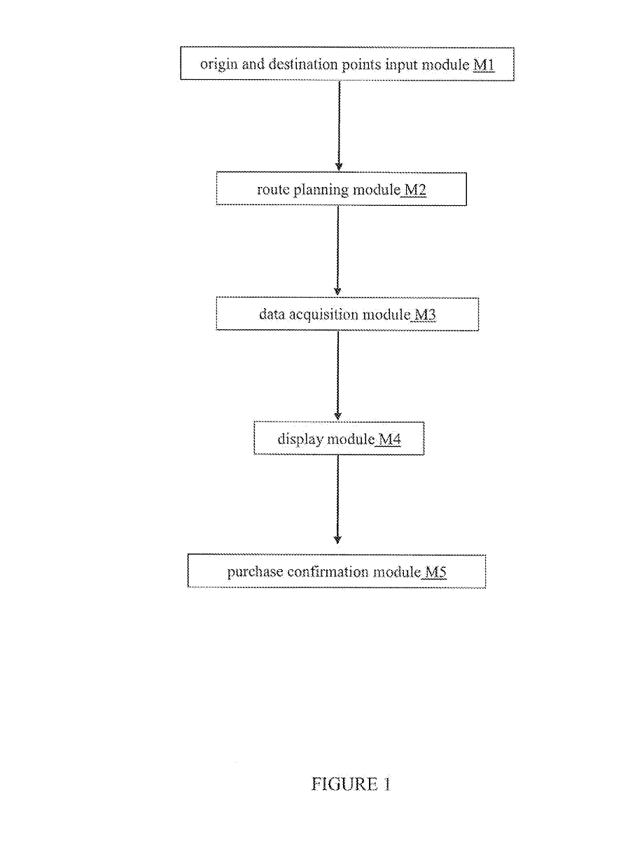

According to FIG. 1, another embodiment of the present invention computer program product for purchasing goods via transnational shipping is shown, where the computer program product can be installed on a mobile electronic device, a tablet PC, or a notebook computer; and after the program is executed, shipping method can be selected, and the rent of each required transport vehicle as well as the required customs fees can be paid through online purchasing.

An embodiment of the computer program product comprises an origin and destination points input module M1, a route planning module M2, a data acquisition module M3, a display module M4, and a purchase confirmation module M5.

The origin and destination points input module M1 allows the user to input the point of departure and the destination of the goods to be shipped. The route planning module M2 provides a list comprising at least one possible route of completing the shipping according to the points of departure and destination entered, and the means of transportation that can be utilized. Of course, this route list can include routes that can be completed by using various kinds of vehicles.

The data acquisition module M3 acquires data about the number of flights/runs of the vehicles used on said route, and the time and costs required for each corresponding flight/run; and can sort out the shortest possible time required for completing the corresponding shipping. The display module M4 is used to display the acquired data about the number of flights/runs, and the time and costs required for each corresponding flight/run; and also display the total required time and total costs for said route (including customs fees or taxes).

The purchase confirmation module M5 is used to enable the user decide on using the route or not and make the required payment. Should the user decide to use route provided by this product and make payment; reservation is made for each corresponding vehicle, following collection of the payment. As a result, the complicated tasks of the prior art is simplified, and also the time of arrival can be directly confirmed and the manual computation/estimation mistakes of the prior art techniques can be eliminated. Moreover, as told above, the payment is not directly made to the service provider, and therefore, there is no need to apply for a letter of credit etc. bank voucher. As a result, both the use and the service provider don't have to worry about extra expenses such as the ones that would occur due to bank service charges.

Moreover, the data acquisition module M3 acquires data about the number of flights/runs on said route, and the time and costs required for each corresponding flight/run through the internet via the electronic device on which the program is installed. Using the server to acquire the required information, the product of the present invention directly downloads the information from the server, which substantially simplifies the downloading of the routes and accelerates the information downloading speed.

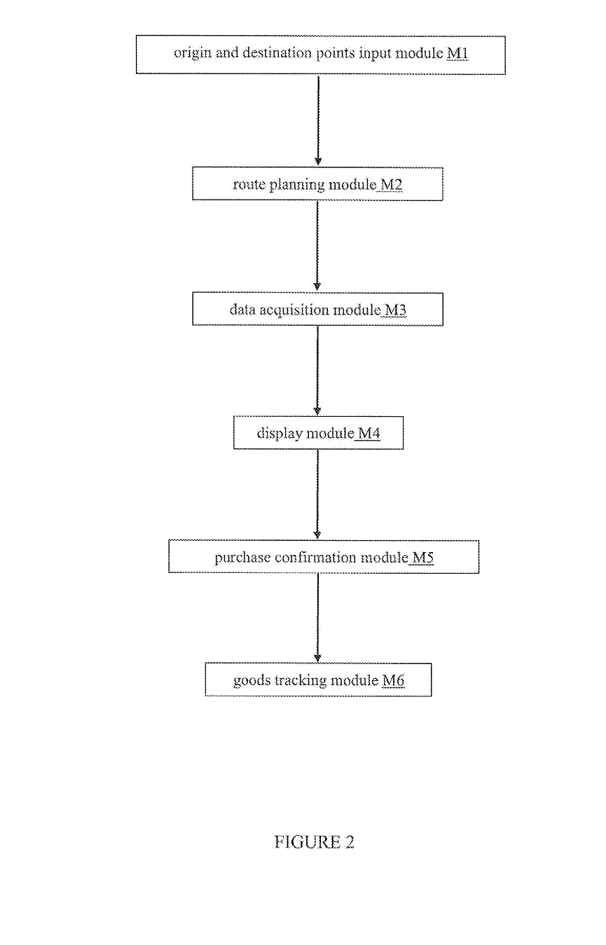

Moreover, according to FIG. 2, an embodiment of the present invention comprises a goods tracking module M6, which is used for showing the place where the goods are found, so that the user can see the location of the goods in real-time, and as a result, the user can plan ahead and prepare for subsequent works.

Moreover, after the data about the location of said goods are acquired via the server, these data can also be downloaded by said goods tracking module M6, and before said goods arrive at a trans-shipment place for change of vehicle, the server issues a reminder notification to the contact window of the next vehicle service provider, so that the service provider can be notified once more to make relevant preparations according to the schedule. As a result, the connection between the shipping stages can be completed in a way that reduces the time the goods are kept waiting between transfers and increases the efficiency of shipment.

Besides, the goods tracking module M6 can also integrate the serial numbers of the goods found in each different shipping stage, so that relate the shipping stages of the goods to each other. As a result, by means of using the serial number of the goods found in each different shipping stage, it would be possible to inquire the real-time location or situation of the goods, which helps forming interconnection between goods shipment information, and which is not limited in inquiring the serial number provided for the corresponding specific stopping stage, so that overcomes the drawbacks of the prior art. technique. Moreover, the goods tracking module M6 is also compatible with an image capturing unit; and therefore, images of the goods can be captured via the image capturing device at any time or at certain points, for instance at the trans-shipment places where the goods are kept waiting. In this way, the photos of the goods can be acquired when they enter the storehouse at the trans-shipment place and the photos can be acquired again when they leave the storehouse at the trans-shipment place, so that by means of comparing the images of the goods, it can easily be understood, if the goods have been opened, if there are missing goods, or wrong goods are sent. Also, in these cases, it would be possible to investigate the responsible parties or track the goods. When tracking the location of the goods, it would of course be possible to provide the exterior view of the goods to the user while they leave the storehouse.

Moreover, the data acquisition module M3 can also acquire real-time weather information and weather forecast information, and then show it on the display module. According to the impact to be caused by said real-time weather information and said weather forecast information on the completion time of the route, it also shows the total time and total costs required, after taking into account said impacts on the route. In this way the accuracy of the arrival time and the costs would be improved.

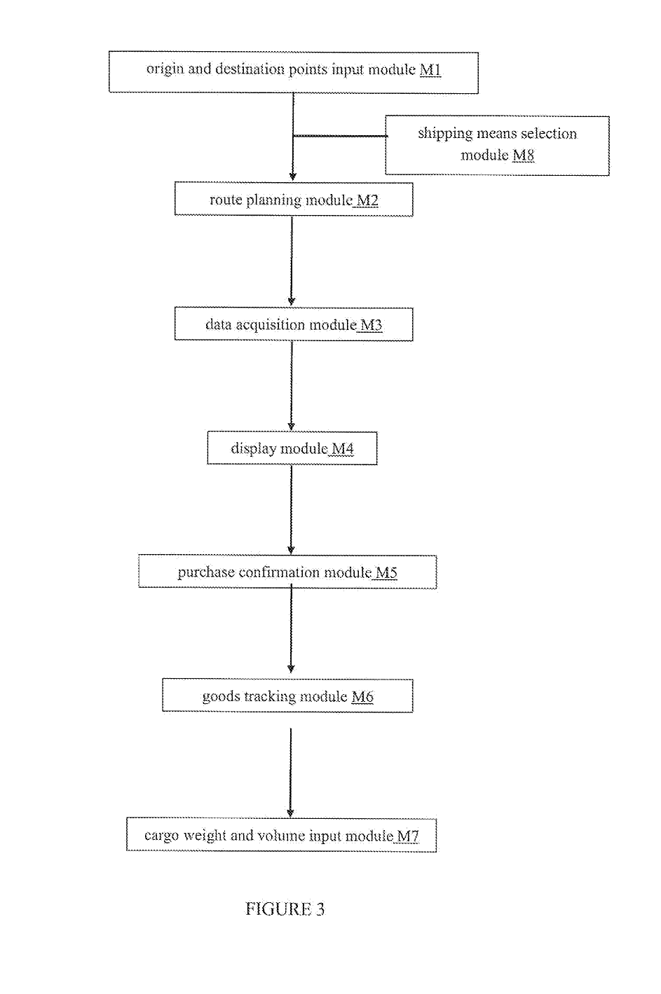

According to FIG. 3, an embodiment of the present invention also comprises a cargo weight and volume input module M7, which is used to enable the user to enter the weight information and the volume information of the goods; and the total required time and total required costs are re-assessed by taking into account the impacts of the weight arid volume information. For example, when added to a container, if the weight of the goods added and the weight of the goods that are already found in the container exceeds the standard total weight limit, in this case, another container is required to be arranged, and therefore delays may occur in the shipment, which would affect the arrival time of the shipment.

The present invention also comprises a shipping means selection module M8, which is used for allowing the user to choose the means of transportation, and thus simplifies the task of selecting the remaining routes. When the user is in a particular situation, he/she can first choose the particular means of transportation, so that selection of the remaining tasks would become easier.

In summation of the description above, the present invention overcomes the drawbacks of the prior art and provides the use with convenient shipment plans, and also, following confirmation of the route by the user and receiving the payment, performs the tasks such as making reservation for the required vehicles. While the invention has been described by means of specific embodiments, numerous modifications and variations could be made thereto by those skilled in the art without departing from the scope and spirit of the invention set forth in the claims.

What is claimed is:

1. A computer program product for purchasing goods via transnational shipping, comprising:
an origin and destination points input module, which allows the user to input the point of departure and the destination of the goods to be shipped,
a route planning module, which provides a list comprising at least one possible route of completing the shipping according to the points of departure and destination entered,
a data acquisition module, which acquires data about the number of flights/runs of the vehicles used on said route, and the time and costs required for each corresponding flight/run,
a display module, which is used to display the acquired data about the number of flights/runs, and the time and costs required for each corresponding flight/run, and also display the total required time and total costs for said route, and
a purchase confirmation module, which is used to enable the user decide on using the route or not and make the required payment.

2. A computer program product for purchasing goods via transnational shipping according to claim 1, wherein said data acquisition module acquires data about the number of flights/runs, and the time and costs required for each corresponding flight/run from a server through a network.

3. A computer program product for purchasing goods via transnational shipping according to claim 1, wherein it also comprises a goods tracking module, which is used for showing the location of the goods.

4. A computer program product for purchasing goods via transnational shipping according to claim 3, wherein said location of the goods is acquired from a server and downloaded to said goods tracking module, and before said goods arrive at a trans-shipment place for change of vehicle, a reminder notification is issued by said server to the contact window of the next vehicle.

5. A computer program product for purchasing goods via transnational shipping according to claim 1, wherein said data acquisition module can also acquire real-time weather information and weather forecast information, and show the information on the display module, and can also acquire information about the impact of said real-time weather information and said weather forecast information on the completion time of the route, and then show the total time and total costs required after taking into account said impacts on the route.

6. A computer program product for purchasing goods via transnational shipping according to claim 1, which also comprises a cargo weight and volume input module, which is used to enable the user to enter the weight information and the volume information of the goods; and the total required time and total required costs are re-assessed by taking into account the impacts of the weight and volume information.

7. A computer program product fur purchasing goods via transnational shipping according to claim 1, which also comprises a shipping means selection module, which is used for allowing the user to choose the means of transportation.

8. A method of purchasing goods via transnational shipping, which provides at least one shipping route according to the origin and destination points entered by the user, via the server; and also gives an estimation of the required time and costs according to the vehicles used on said shipping route; and after the user confirms the route and makes the payment, places the shipping service order to corresponding vehicle service providers.

9. A method of purchasing goods via transnational shipping according to claim 8, wherein said server acquires data about the number of flights/runs of the vehicles used on said shipping route, and the time and costs required for each corresponding flight/run, and the real-time weather information and the weather forecast information, and also makes an estimation of the requited time and costs according to the data/information acquired.

10. A method of purchasing goods via transnational shipping according to claim 9, wherein said server also monitors the location of the goods, and before the goods arrive at a trans-shipment place for change of vehicle, it issues is reminder notification to the contact window of the next vehicle.
